(19) United States
(12) Patent Application Publication
(10) Pub. No.: US 2014/0214584 A1
(43) Pub. Date: Jul. 31, 2014

(54) MOBILE DEVICE AUCTION SYSTEM AND METHOD

(71) Applicant: Johann Dorfi, Monterrey (MX)

(72) Inventor: Johann Dorfi, Monterrey (MX)

(21) Appl. No.: 13/753,961

(22) Filed: Jan. 30, 2013

(51) Int. Cl. G06Q 30/08

(52) U.S. Cl. CPC G06Q 30/08
USPC 705/26.3

(57) ABSTRACT

A system and method designed for conducting bidding at auctions. The system may include an information server with a database for holding bid information; one or more wireless controllers with an application program for translating operations of a user into bid information that is transmitted to the information server; and a data communication network for providing wireless communication along at least part of the path between the wireless communicator and the information server. The method may include using the system including the application program generating data signals with bid information based on actions of the use on the wireless communicator. The actions translated by the application program may simulate some bidding behaviors common to live auction environments.

### BACKGROUND OF THE DISCLOSURE

1. Field of the Disclosure

This disclosure generally relates to the field of auctions, and, in particular, conducting bidding using wireless communicators.

2. Description of the Art

Auctions have been used for obtaining a best available price in the selling goods and services for centuries. Traditionally, auctions are associated with bidders sitting in a room with an auctioneer, who facilitates bidding on items to be auctioned. Bidders are usually able to be in the presence of their competition for the articles up for bid. A bid may be accepted when the bidder is recognized by the auctioneer. Traditional auctions occasionally suffer from bids that are too close together in time; hence the auctioneer may have difficulty determining which bidder made a particular bid first. The debate about who bid first may become problematic in some situations. It is also difficult for the auctioneer and bidders to gauge the level of participation of the bidders for auction items, other than the amount of the highest bid and the duration of bidding process. Spending by individual bidders, particularly those to which credit has been extended, is not tracked or checked in real-time. Overall, feedback to the auctioneer and individual bidders may be limited to their individual observations, and this may be an added handicap to bidders who are not physically present at the auction and/or not able to visually observe the auction proceedings.

Modern technology has provided for changes to improve auction effectiveness. The Internet has brought about on-line auctions, where bidders may submit electronic bids from a computer. Bidding websites may expand the scope of the auction audience but may also lack the feel of a traditional auction that is desired by some bidders. Bidders may be isolated and unable to read and view the disposition of their competition. What is needed is a system that blends the bidding features of traditional auction with the tie breaking, real-time feedback, bidding management, and flexibility enhancements of modern technology.

### BRIEF SUMMARY OF THE DISCLOSURE

In aspects, the present disclosure is related to an auction system and method. Specifically, the present disclosure is related to using wireless communication devices for performing auction operations.

One embodiment according to the present disclosure includes system for auction bidding, comprising: an information server, the information server comprising: a database configured to store bidding information; a data communication network in communication with the information server; and at least one wireless communicator in communication with the data communication network, wherein each of the at least one wireless communicator comprises: a processor; a wireless communication module configured to facilitate wireless communication; an accelerometer; a memory configured to store an application program; and an interface configured to facilitate operation of the application program by the processor, wherein the application program includes instructions to: receive bidding information from the interface, receive commands from the accelerometer; and transmit the bidding information to the information server using the data communication network. In some embodiments, the interface may include a touch screen. In some embodiments, the commands may be received from the touch screen and/or the accelerometer.

Another embodiment according to the present disclosure includes a method of auction bidding, the method comprising: providing bidding information to a database on an information server over a data communication network by performing an operation on at least one wireless communicator configured to generate a data signal based on the operation performed and bidding is initiated by movement of the at least one wireless communicator. In some embodiments, the method may include finger movements on an interface of the at least one wireless communicator to adjust bid amounts.

Another embodiment according to the present disclosure includes an non-transitory computer-readable medium product, the non-transitory computer-readable medium containing instructions thereon that, when executed by at least one processor, perform a method, the method comprising: providing bidding information to a database on an information server over a data communication network by generating a data signal responsive to a user operation performed on at least one wireless communicator, wherein the user operation is indicative of the bidding information and bidding is initiated by movement of the at least one wireless communicator.

Examples of the more important features of the disclosure have been summarized rather broadly in order that the detailed description thereof that follows may be better understood and in order that the contributions they represent to the art may be appreciated. There are, of course, additional features of the disclosure that will be described hereinafter and which will form the subject of the claims appended hereto.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1a shows an auction system according to one embodiment of the present disclosure;

FIG. 1b shows another auction system according to one embodiment of the present disclosure;

FIG. 2a shows a flow chart of a method for conducting auction bidding according to one embodiment of the present disclosure.

FIG. 2b shows a flow chart of another method for conducting auction bidding according to one embodiment of the present disclosure.

FIG. 3a shows a wireless communicator according to one embodiment of the present disclosure;

FIG. 3b shows auctioneer features of a wireless communicator according to one embodiment of the present disclosure;

FIG. 3c shows bidder features of a wireless communicator according to one embodiment of the present disclosure;

FIG. 4 shows an exemplary starting movement for bidding according to one embodiment of the present disclosure;

FIG. 5 shows an exemplary selected movement according to one embodiment of the present disclosure;

FIG. 6 shows an exemplary bidding increment adjustment according to one embodiment of the present disclosure; and

FIG. 7 shows an exemplary accept/decline finger movement according to one embodiment of the present disclosure.

### DETAILED DESCRIPTION OF THE DISCLOSURE

Generally, the present disclosure relates to auctions, specifically involving the use of a wireless communicators and a centralized bidding information system. The present disclosure is susceptible to embodiments of different forms. There are shown in the drawings, and herein will be described in detail, specific embodiments of the present disclosure with the understanding that the present disclosure is to be considered an exemplification of the principles of the present disclosure and is not intended to limit the present disclosure to that illustrated and described herein.

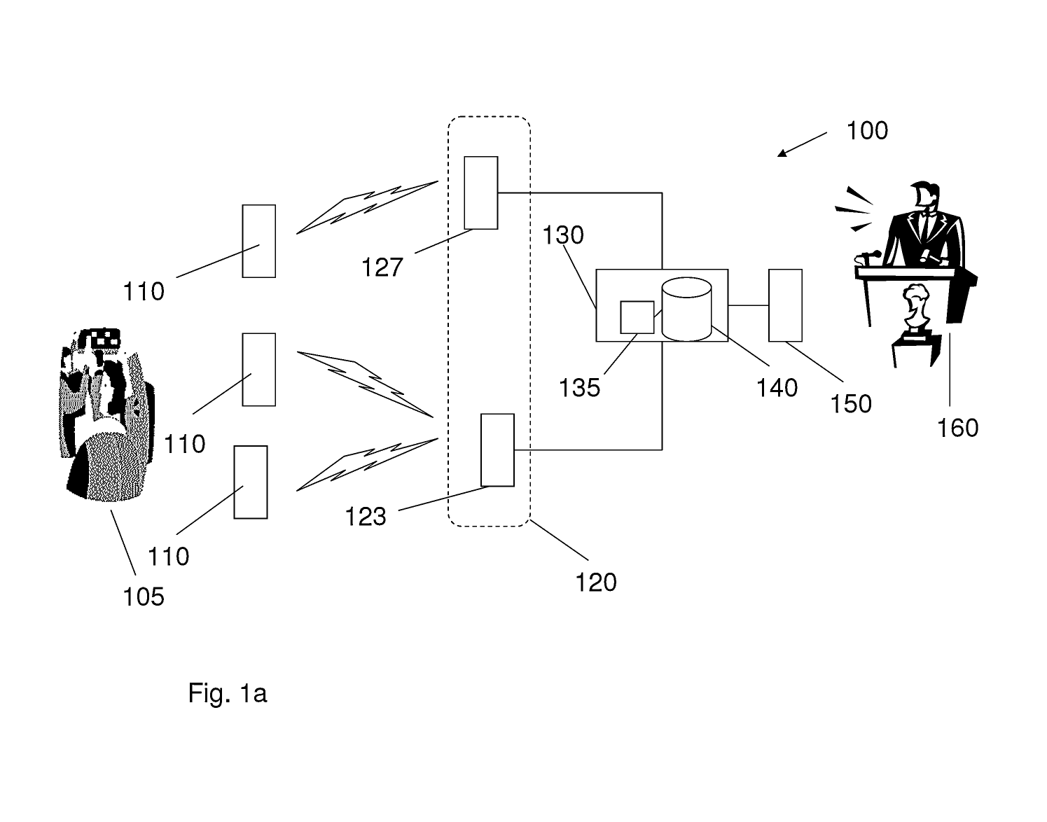

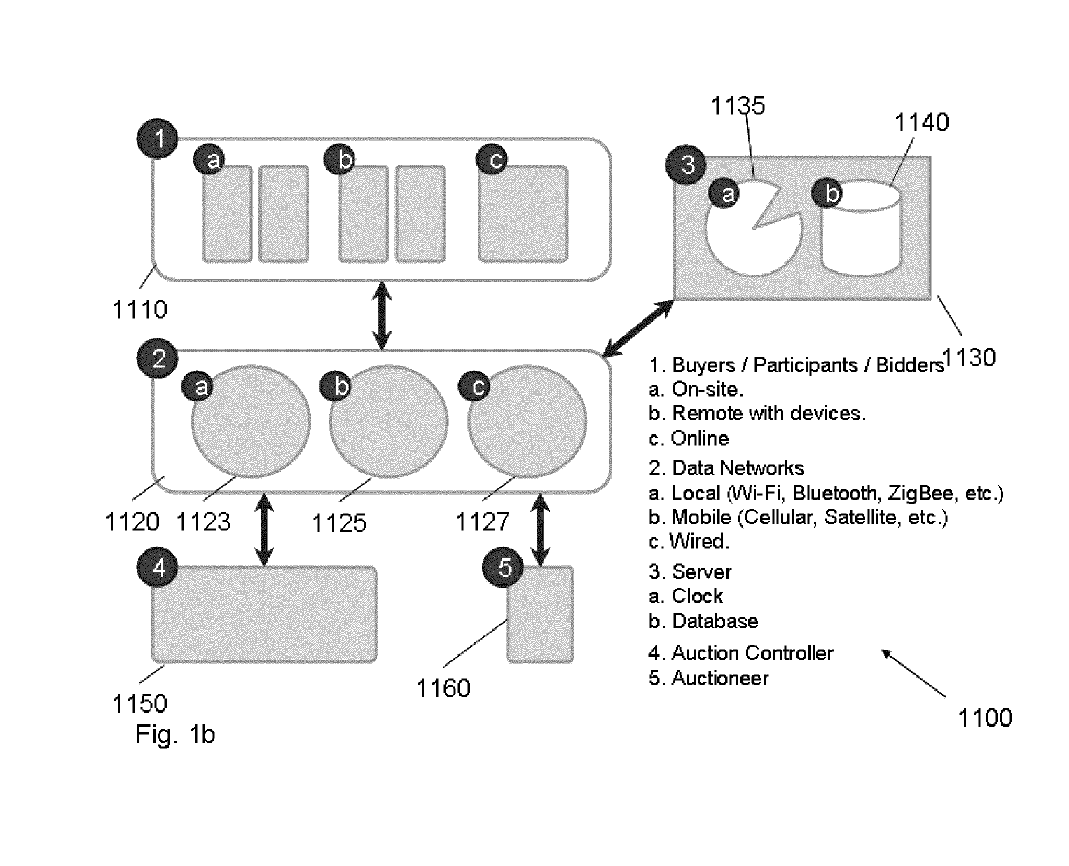

FIG. 1a shows a diagram of an exemplary auction system 100 according to one embodiment of the present disclosure. The auction system 100 may include one or more wireless communicators 110 in communication with an information server 130 over a data communication network 120. The wireless communicator 110 may include an application program configured to perform a method for translating actions of a user into bidding information that may be transmitted over the data communication network 120. Suitable wireless communicators may include, but are not limited to, smart phones and tablet computers. In some embodiments, the wireless communicators 110 may include auction dedicated wireless devices that may be distributed to bidders. The data communication network 120 may include a wireless local area network 123 (such as, but not limited to, one or more of: Wi-Fi, Bluetooth, and ZigBee) and/or a cellular data network 127. The use of wireless local area networks and cellular data networks are exemplary and illustrative only, as any suitable data communication network capable of receiving/transmitting data to the wireless communicator 110, as understood by one of ordinary skill in the art, may be used. The data communication network 120 may include wired components downstream of the wireless communication with the wireless communicators 110. While FIG. 1a shows a wired connection between data communication network 120 and information server 130, this is illustrative and exemplary only, as wired and/or wireless communication may be used in the communication path between the data communication network 120 and the information server 130. The data communication network 120 may include cloud and/or Internet components (not shown). The information server 130 may include a database 140 configured to store bidding information. The bidding information may include one or more values. The information server 130 may include at least one clock 135 configured to provide time stamps for incoming/outgoing bidding information. In some embodiments, a time stamp may be associated with one of the values. The time stamps associated with the bidding information may be stored in the database 140. The information server 130 may be in communication with an auction controller 150. The auction controller 150 may be configured to receive/transmit bidding information between the auctioneer 160 and the information server 130.

In operation, one or more bidders 105 may initiate bidding operation or command using wireless communicators 110, and information regarding the bidding operation or command may be transmitted to the information server 140 over the data communication network 120. An auctioneer 160 conducting the auction may access bidding information stored in the database 140 on the information server 130 using the auction controller 150.

FIG. 1b shows a diagram of another exemplary auction system 1100 according to one embodiment of the present disclosure. The auction system 1100 may include one or more auction parties 1110 in communication with an information server 1130 over a data communication network 1120. The parties may communicate with the data communication server 1120 using one or more communication means, including, but not limited to, on-site communication, remote communication using a wireless communicator 110, and on-line. The auction parties 1110 may communicate with the information server 1130 using an application program configured to perform a method for translating actions of a user into bidding information that may be transmitted over the data communication network 1120. Suitable wireless communicators may include, but are not limited to, smart phones and tablet computers. In some embodiments, the auction parties 1110 may use dedicated wireless devices that are distributed by the organization conducting the auction. The data communication network 1120 may include one or more of a local wireless data network 1123 (Wi-Fi, Bluetooth, ZigBee, etc.), a mobile data network 1125 (cellular, satellite, etc.), a wired network 1127, and cloud and/or Internet components (not shown). The information server 1130 may include a database 1140 configured to store bidding information. The bidding information may include one or more values. The information server 1130 may include at least one clock 1135 configured to provide time stamps for incoming/outgoing bidding information. In some embodiments, a time stamp may be associated with one of the values. The time stamps associated with the bidding information may be stored in the database 1140. The information server 1130 may be in communication with an auction controller 1150. An auctioneer 1160 may communicate over the information data network 1120. In some embodiments, the auctioneer 1160 may use access the information data network 1120 with or without the aid of the auction controller 1150.

In operation, one or more of the parties 1110 may initiate bidding operation or command using wireless communicators 110, and information regarding the bidding operation or command may be transmitted to the information server 1140 over the data communication network 1120.

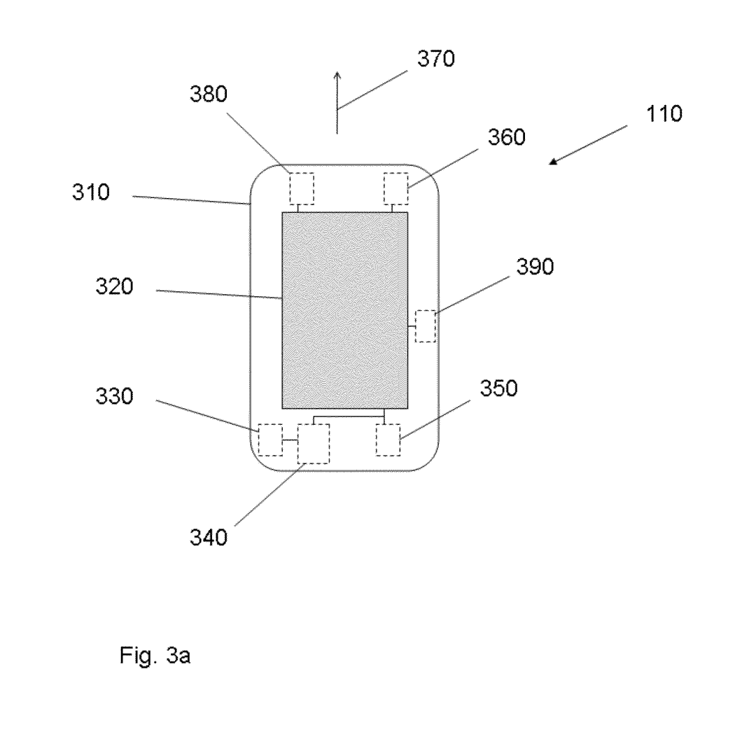

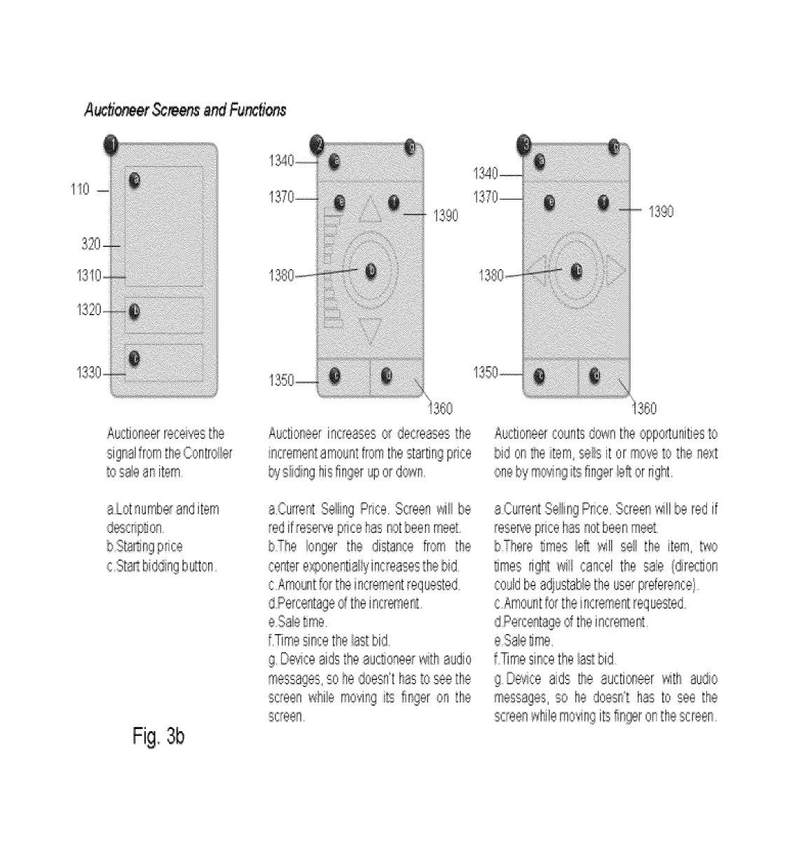

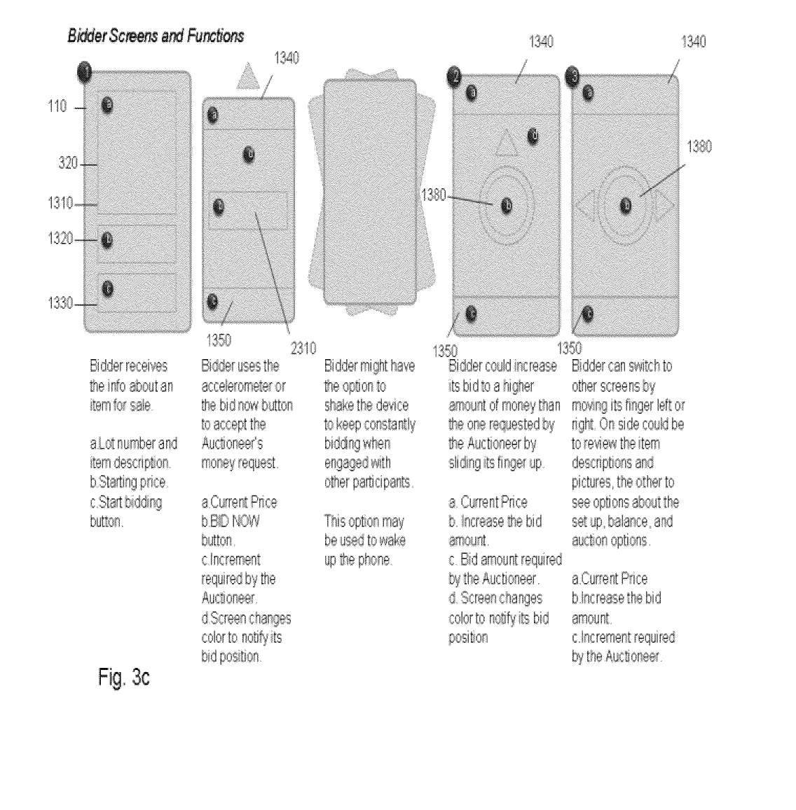

In some embodiments, the wireless communicators 110 may be configured, by way of the application program, to generate an audible signal due to an input from one of the parties 1110. The audible signal may be one or more of: (i) an verbal sound (spoken word) and (ii) a non-verbal sound (tone, beep, etc.). The wireless communicators may be configured to issue the audible signal in response to an adjustment of the bid amount or increment. For example, the auctioneer 160, 1160 may move a finger on the interface 320 (see FIGS. 3a-3b) to adjust the amount of the bid requested. The wireless communicator 110 may issue the audible signal as the auctioneer's finger increments the bid amount by a selected amount. In some embodiments, the interface 320 may be configured to produce an audible signal (such as a vocal rendering of the current bid price) when the interface 320 is touched. The audible signal feature facilitates the auction process by allowing the parties 1110 to receive feedback from the wireless communicator 110 without needing to look at the interface 320 or any other information displayed on the wireless communicator 110. The audible signal feature may be enabled for all parties 1110 or selected parties (e.g. auctioneer 160, 1160 only).

In another embodiment, the bid information generated by the auctioneer 160, 1160 may be displayed for the auctioneer 160, 1160 on one or more monitors or other suitable display device. The bid information generated by the auctioneer 160, 1160 may not be viewable by all parties 1110. The bid information of the auctioneer 160, 1160 may be viewable by the auction controller 150.

In some embodiments, the wireless communicator 110 may be configured to initiate a command when contact with the interface 320 is discontinued. For example, an auctioneer 160, 1160 may adjust a starting price using finger movements on the interface 320 and have the new starting price communicated as soon as the auctioneer's finger contact with the interface 320 is discontinued. In other embodiments, the wireless communicator 110 may be configured with additional layers of confirmation checks, so that an adjustment input into the interface 320 is not accidentally transmitted. Thus, as would be understood by one of ordinary skill in the art, the wireless communicator 110 may be configured to vary the number of steps required to communicate a command, which allows the user to balance quick response with accident command mitigation.

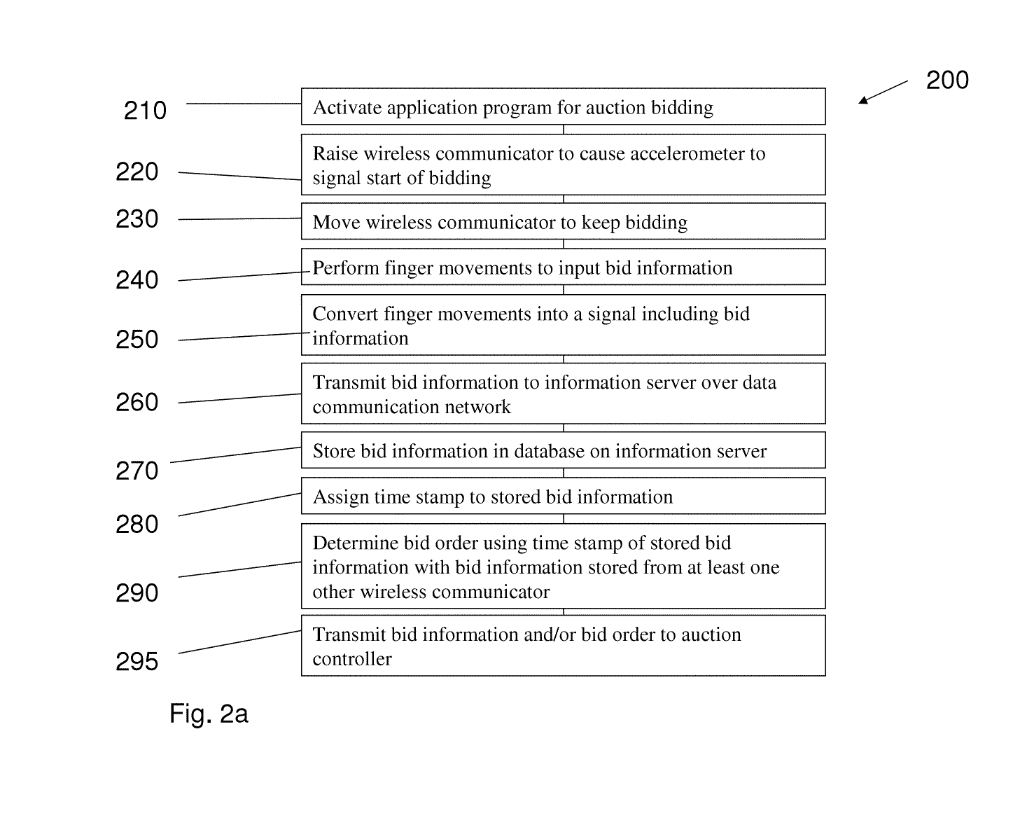

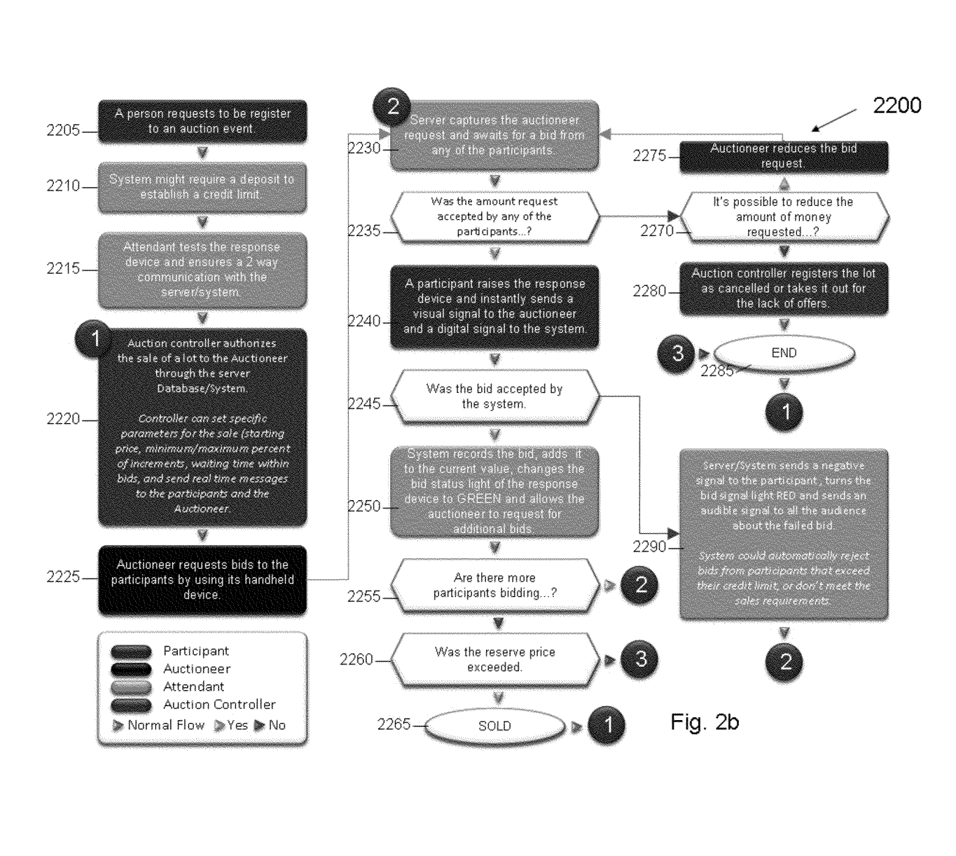

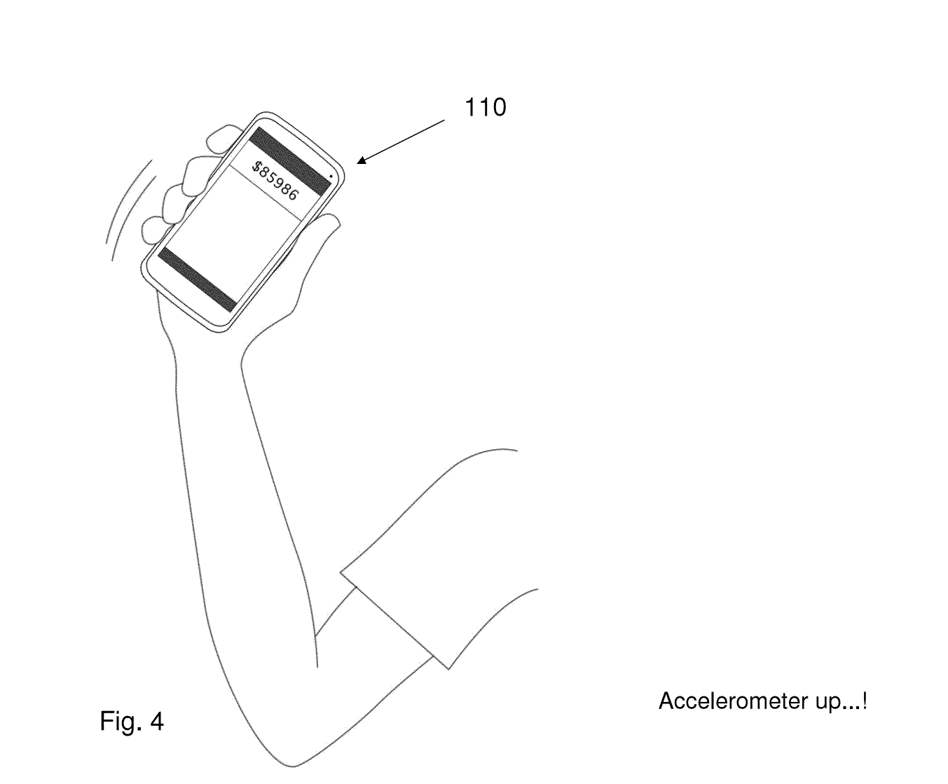

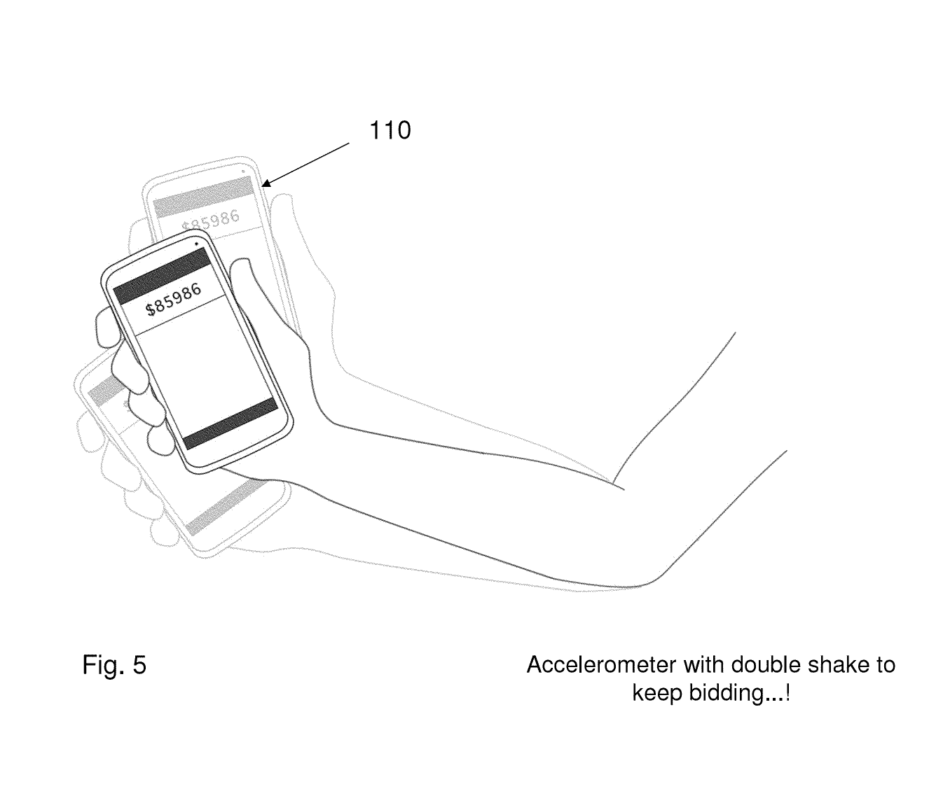

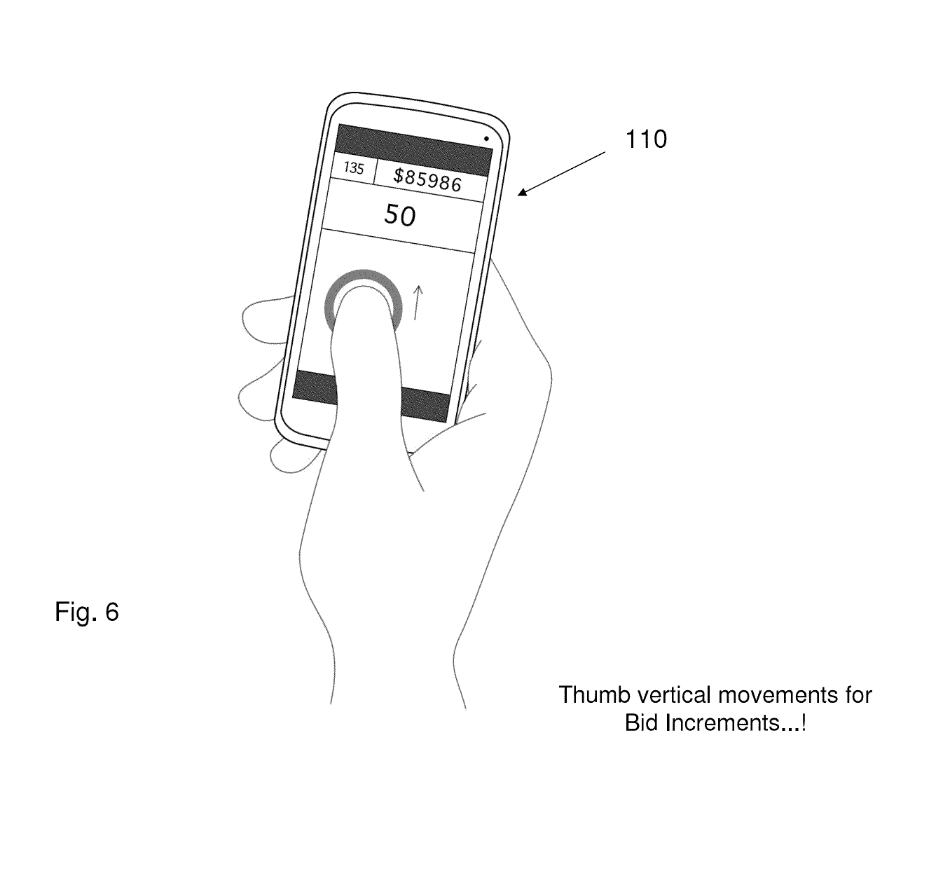

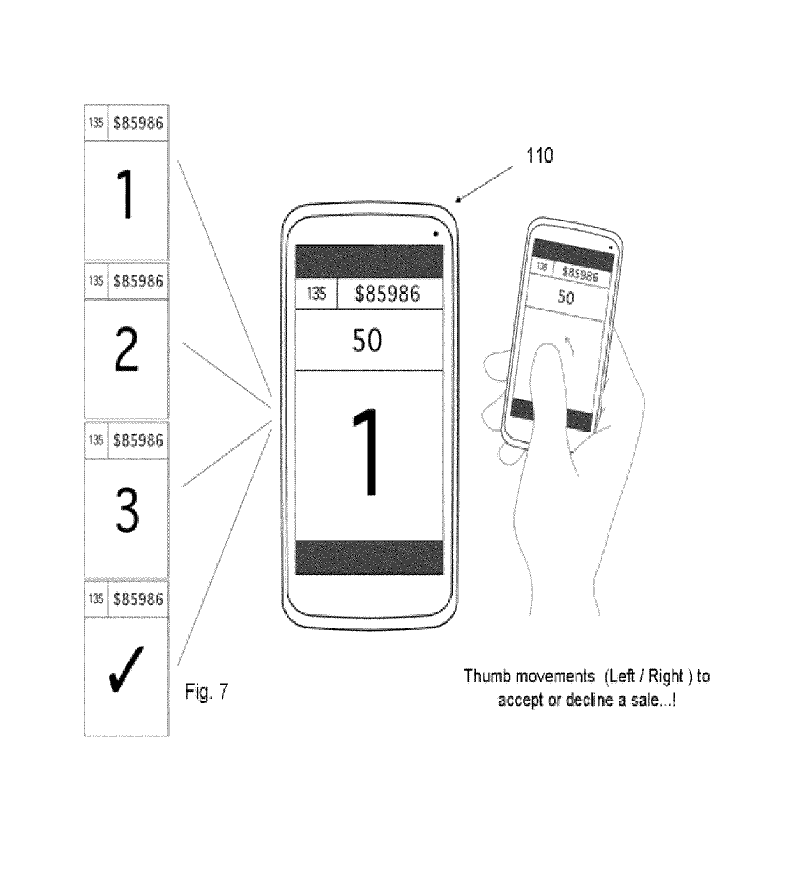

FIG. 2a shows a flow chart of a method 200 for conducting an auction according to one embodiment of the pending disclosure. In step 210, the auction application program resident on a wireless communicator 110 may be activated. In step 220, the user may raise the wireless communicator 110 to start the bidding process (see FIG. 4). The wireless communicator 110 may include an accelerometer 350 (see FIG. 3a) configured to detect the raising motion and/or an orientation of the wireless communicator 110 relative to an axis 370 (see FIG. 3a) of the wireless communicator 110. In step 230, the user may perform a movement to indicate to the application program that the bidder 105 wants to continue bidding. In some embodiments, the selected movement may include one or more of: raising the wireless communicator 110, changing an orientation of the wireless communicator 110, and a double shake of the wireless communicator 110 (see FIG. 5). In some embodiments, step 230 is optional. In step 240, the user may perform an operation (such as finger movements) on the wireless communicator 110 to input information into to wireless communicator 110. The user may be the bidder 105 or the auctioneer 160. Using finger movements as an example, the operation may be relative to the axis 370 of the wireless communicator 110 (Up, Down, Left, Right, and combinations thereof). The finger movements may be performed regardless of the orientation of the wireless communicator 110 relative to axis 370. In some embodiments, the finger movements may include a movement of any finger, including the thumb. In some embodiments, finger movements may include vertical movements, horizontal movements, and taps. In some embodiments, the finger movements may be performed on an interface 320 (see FIG. 3a) disposed on the wireless communicator 110. Some finger movements may be associated with specific information inputs. For example, vertical finger movement may indicate increases (upward)/decreases (downward) in bid increments (FIG. 6); and horizontal finger movements may indicate accepting (leftward)/declining (rightward) of a sale (FIG. 7). The finger movements may indicate bid incremental changes that are at least one of: linear and exponential. In step 250, the application program may convert the finger movements into a data signal that includes the bid information. In step 260, the wireless communicator 110 may transmit the bid information to an information server 130 over a data communication network 120. Step 260 may be initiated by a movement (such as pressing an icon on or raising the wireless communicator 110) after acceptance of a sale. While the bid may be transmitted after the sale movement initiating the bid in step 260, information may be transmitted between the wireless communicator 110 and the information server 130 throughout the bidding process. Transmitted information may include, but is not limited to, bid limits, credit limits, bid increment restrictions, waiting time within bids, acceptance/rejection of the bid by the information server 130, and starting price. Information may also be transmitted due to specific commands received from the auction controller 150, such as, but not limited to, a lockout/unlock of bidding privileges (automatic or manually initiated by auctioneer 160), bid requests, and statistical polling. In some embodiments, step 260 may include bidirectional communication between the wireless communicator 110 and the information server 130. In step 270, the information server 130 may store the bid information in a database 140. In step 280, a time stamp may be generated using a clock 135 and may be assigned to the bid information in the database 140. In step 290, a bid order may be determined by the information server 130 based on the time stamp associated one a value of the bid information and a time stamp on at least one other value of the bid information. In some embodiments, step 290 may be optional. In step 295, the bid order and/or at least part of the bid information may be transmitted to the auction controller 150. The auctioneer 160 may access the bid information through the auction controller 150.

FIG. 2b shows a flow chart of a method 2200 for conducting an auction according to one embodiment of the pending disclosure. In step 2205, an auction party 1110 requests to be registered for an auction event. In step 2210, a deposit may be collected from the auction party 1110 to establish a credit limit. In some embodiments, step 2210 may be optional. In some embodiments, the bids by the auction party 1110 may be tracked against or reconciled with the credit limit. In step 2215, the auction application program resident on a wireless communicator 110 may be activated and validated as operationally communicating with the information server 130, 1130. In step 2220, the auction controller 150, 1150 may communicate an authorization for a sale of a lot (item to be auctioned) to an auctioneer 160, 1160. The auction controller 150, 1150 and/or the auctioneer 160, 1160 may set specific parameters for the auction process may, including, but not limited to, one or more of: i) starting price, ii) minimum/maximum increments for bidding (absolute or percentage), and iii) waiting time within bids. The auction controller 150, 1150 and/or auctioneer 160, 1160 may also communicate with the auction parties 1110 via real-time messages. In some embodiments, the real-time messages may include text and/or audio format. In step 2225, the auctioneer 160, 1160 may send a request for bids to the auction parties 1110 using a wireless communicator 110. In step 2230, the information server 140, 1140 may log the request for bids and wait on bids from the auction parties 1110. In step 2235, information server 140, 1140 checks on whether the bid request amount has been accepted by one or more of the auction parties 1110. In some embodiments, the auction parties 1110 may include non-bidders, and, thus, not all auction parties 1110 will send in bids. If the bid amount has been accepted, then, in step 2240, an auction party 1110 may raise the wireless communicator 110 to start the bidding process. The act of raising the wireless communicator 110 may visually signal a bid and trigger the wireless communicator 110 to send a data signal transmitting a bid to the information server 130, 1130. (see FIG. 4). The wireless communicator 110 may include an accelerometer 350 (see FIG. 3a) configured to detect the raising motion and/or an orientation of the wireless communicator 110 relative to an axis 370 (see FIG. 3a) of the wireless communicator 110. In step 2245, a check is made as to whether the bid was accepted by the information server 130, 1130.

If the bid is not accepted, then a negative message is sent regarding the submitted bid in step 2290. The negative message may include one or more of: i) a signal light (red light) on the wireless communicator 110 one or more of the auction parties 1110 and ii) an audible signal to all of the auction parties 1110. In some embodiments, the submitted bid may be rejected by the information server 130, 1130 if the submitted bid exceeds the credit limit for the bidder. After the rejection of the submitted bid, part of the method may repeat, beginning at step 2230.

If the submitted bid is accepted, then the submitted bid is recorded by the information server 130, 1130 in step 2250. The information server 130,1130 may update the value of the bid on the item being auction and send a signal to illuminate a light (green light) on the wireless communicator 110 of one or more auction parties 1110. In step 2255, a check is made to see if there are additional bids. If there are additional bids, the method begins again at step 2230. If there are no additional bids, then the current highest bid is checked against the reserve price in step 2260. If the reserve price is exceed, the auction item is sold in step 2265. If the reserve price is not exceeded, the auction for the item ends in step 2285. After the auction for an item ends, the method may restart for a subsequent auction item in step 2220.

Returning to step 2235, if the amount requested is not accepted, then a check is performed as to whether the requested amount may be reduced in step 2275. If the requested amount may be reduced, then, in step 2275, the auctioneer 160, 1160 may reduce the amount of the bid request and the process continues in step 2230. If the requested amount may not be reduced, in step 2280, the auction controller 150, 1150 may register the item for auction as canceled or withdrawn from auction for lack of offers and ends the auction for the item in step 2285.

In some embodiments, the raising/reorienting/shaking of the wireless communicator 110 in step 2240 may be replaced with an alternative action, for instances where the bidder 105, 1100 may be unable to or simply choose to not raise the wireless communicator 110 to make the selected movement. The alternative action may include, but is not limited to, one or more of: (i) pressing a dedicated button (real or virtual) and (ii) a voice command.

In some embodiments, exemplary auction system 100 or 1000 may be used for reverse auctions, such as for a purchasing department. In a reverse auction, the auctioneer 160, 1160 may be collecting the lowest bid from bidders 105, 1100. As would be understood by one of ordinary skill in the art, a reverse auction may be performed using methods 200 or 2200 by modifying steps (such as step 2260) such that the lowest price is checked against the reserve price and bidding advances as the bid price decreases.

FIG. 3a shows a diagram of an exemplary wireless communicator 110 according to one embodiment of the present disclosure. The wireless communicator 110 may include a housing 310 with an interface 320 disposed on it. The interface 320 may include one or more of: (i) a touch sensitive display, (ii) buttons, (iii) a track ball, and (iv) a joystick (physical or simulated). The interface 320 may be configured for multi-role use. For example, an interface 320 with a touch sensitive display may be configured to display information for an auctioneer 160, 1160 and, separately, display information for an auction party 1110, such as a bidder. The wireless communicator 110 may also include a memory 330 that may be configured to store the application program for translating inputs from the interface 320 to a data signal including bidding information. Finger movements on the interface 320 indicative of bidding information may be converted to the data signal when the inputs from the interface 320 and/or accelerometer 350 are received by a processor 340 that executes the application program stored on the memory 330. The processor 340 may be configured to initiate transmission of bid information received through interface 320 based on a signal received from accelerometer 350. In some embodiments, the memory 330 may include a suitable non-transitory computer readable medium as would be understood by one of ordinary skill in the art, including, but not limited to, one or more of: (i) a ROM, (ii) an EPROM, (iii) a hard disk, (iv) a non-volatile memory, (v) a memory card, and (vi) a flash memory. The wireless communicator 110 may also include a wireless communication module 360. The data signal containing the bidding information may be transmitted to the data communication network 120 wirelessly using the wireless communication module 360. The wireless communication module 360 may be any circuit configured to provide wireless connectivity as would be understood by one of ordinary skill of the art. In some embodiments, the wireless communicator 110 may include or more audio outputs. The audio outputs may include speakers and/or an option for ear plug jacks 380 for the audible feedback. In some embodiments, the wireless communicator 110 may include a vibration mechanism 390 that may provide vibrations as feedback to bidders.

FIG. 3b shows a diagram of an exemplary wireless communicator 110 of FIG. 3a with auctioneer features according to one embodiment of the present disclosure. When the auctioneer 160, 1160 receives a data signal that an item is ready to be auctioned as in step 2220, the interface 320 may indicate the lot number/item description 1310, the starting price 1320, and the “Request Bids” button 1330. The auctioneer 160, 1160 may adjust the starting price from current selling price 1340 using finger movements on the interface 320 at 1380. The degree of the finger movements in an up or down motion may determine the increase or decrease in the selling price increment. The increase or decrease may be absolute or percentage based, and the finger motion may generate an increment that is linear or exponential with respect to the degree of finger motion. The increment amount 1350 is displayed, as is the percentage of the increment 1360. The interface 320 may also display the sale time 1370 and the time since the last bid 1390. If the current selling price 1340 is below a reserve price, then the current selling price 1340 may be displayed in red. The current selling price 1340 may be transmitted to the auction parties as in step 2225.

During the bidding process, the auctioneer 160, 1160 may control the sale or cancellation of the sale from the wireless communicator 110. The interface 320 may allow left/right finger movements at 1380 to control the sale status. In one embodiment, a finger movement two times to the left may sell the item and a finger movement two times to the right may cancel the sale. The single move left may be used as a countdown signal for the bidders in the sequence “3, 2, 1” and to announce that bidding time is almost over. If a bid is received during the countdown process, the system may review it and, if the bid is accepted, the cycle may start all over again. The number and direction of finger movements for controlling the acceptance/cancellation of the sale may be user configurable.

FIG. 3c shows a diagram of an exemplary wireless communicator 110 of FIG. 3a with bidder features according to one embodiment of the present disclosure. When the bidder 105, 1110 receives a signal that an item is ready to be auctioned, as in step 2225, the interface 320 may display to the bidder the lot number/item description 1310, the starting price 1320, and the start bidding button 1330. The bidder 105, 1110 raise the wireless communicator 110 indicating to the software to accept the offer from the auctioneer 160, 1160. The interface 320 may also display a “BID NOW” button 2310 with the required increment 1350. The interface may change color to indicate the bid position (accepted/not accepted).

When bidding with other auction parties 1110, the bidder 105 may need to shake to wireless communicator 110 to indicate that the bidder is still participating in the bidding process. The bidder 105, 1110 may increase their bid using the interface 320 at point 1380 using a finger motion in an upward direction. The requested bid 1350 set by the auctioneer 160, 1160 may be displayed. Using a left/right finger motion at 1380, the bidder 105, 1110 may move between screens on the interface 320.

While the disclosure has been described with reference to exemplary embodiments, it will be understood that various changes may be made and equivalents may be substituted for elements thereof without departing from the scope of the disclosure. In addition, many modifications will be appreciated to adapt a particular instrument, situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A system for auction bidding, comprising:
an information server, the information server comprising:
a database configured to store bidding information;
a data communication network in communication with the information server; and
at least one wireless communicator in communication with the data communication network, wherein each of the at least one wireless communicator comprises:
a processor;
a wireless communication module configured to facilitate wireless communication;
an accelerometer;
a memory configured to store an application program; and
an interface configured to facilitate operation of the application program by the processor, wherein the application program includes instructions to: receive bidding information from the interface, receive commands from the accelerometer; and transmit the bidding information to the information server using the data communication network.

2. The system of claim 1, wherein the data communication network comprises at least one of: i) a cellular data network and ii) a wireless local area network.

3. The system of claim 1, wherein the application program is configured to receive commands from the interface.

4. The system of claim 1, wherein the information server comprises a clock, and the bidding information comprises at least one value, and wherein the at least one value is associated with at least one time from the clock.

5. The system of claim 1, wherein the interface has an axis and the application program is configured to generate a data signal indicative of the bidding information in response to a finger movement on the interface.

6. The system of claim 5, wherein the application program is further configured to generate an audible signal indicative of the bidding information in response to the finger movement on the interface.

7. The system of claim 5, wherein the data signal is generated when a contact between the finger movement and the interface is discontinued.

8. The system of claim 5, wherein the finger movement relative to the axis of the interface comprises at least one of: (i) an upward movement, (ii) a downward movement, (iii) a rightward movement, and (iv) a leftward movement.

9. The system of claim 5, wherein at least one value of the bidding information is increased/decreased in response to the generated data signal associated with an upward/downward finger movement.

10. The system of claim 5, wherein at least one value of the bidding information indicates acceptance/decline and/or time countdown of a sale in response to the generated data signal associated with a leftward/rightward finger movement.

11. The system of claim 1, wherein the application program is configured to accept bidding inputs after the accelerometer indicates that the wireless communicator has been raised.

12. The system of claim 1, wherein the application program is configured to: continue bidding when the accelerometer indicates a selected movement of the wireless communicator.

13. The system of claim 12, wherein the selected movement is a double shake.

14. The system of claim 1, wherein the interface comprises a touch sensitive display.

15. The system of claim 1, wherein the wireless communication is bidirectional.

16. A method of auction bidding, the method comprising:
providing bidding information to a database on an information server over a data communication network by generating a data signal responsive to a user operation performed on at least one wireless communicator, wherein the user operation is indicative of the bidding information and bidding is initiated by movement of the at least one wireless communicator.

17. The method of claim 16, further comprising:
initiating bidding using the wireless communicator, the wireless communicator including an accelerometer responsive to movement of the wireless communicator.

18. The method of claim 17, wherein initiating bidding includes raising the wireless communicator.

19. The method of claim 16, wherein providing bidding information further comprises:
performing a finger movement indicative of the bidding information on an interface of the wireless communicator;
generating a data signal indicative of the bidding information; and
communicating the generated data signal over a data communication network to an information server.

20. The method of claim 19, wherein the finger movement comprises at least one of: i) an upward movement, ii) a downward movement, iii) a rightward movement, and iv) a leftward movement, wherein the finger movement is relative to an axis of the interface.

21. The method of claim 19, wherein providing the bidding information further comprises:
generating an audible signal indicative of the bidding information in response to the finger movement on the interface.

22. The method of claim 19, wherein the data signal is generated when a contact between the finger movement and the interface is discontinued.

23. The method of claim 16, wherein at least one value of the bidding information is increased/decreased in response to the generated data signal associated with an upward/downward finger movement.

24. The method of claim 16, wherein at least one value of the bidding information indicates acceptance/decline of a sale in response to the generated data signal associated with a leftward/rightward finger movement.

25. The method of claim 16, further comprising:
storing the bidding information in the database on the information server.

26. The method of claim 25, wherein the information server comprises a clock, the method further comprising:
assigning a first time from the clock to a first value of the bidding information from a first wireless communicator of the at least one wireless communicator.

27. The method of claim 25, wherein the at least one wireless communicator comprises a second wireless communicator; the method further comprising:
assigning a second time from the clock to a second value of the bidding information from the second wireless communicator.

28. The method of claim 25, further comprising:
comparing the first time with the second time; and
determining a bid order for the bidding information based on the comparison.

29. A non-transitory computer-readable medium product, the non-transitory computer-readable medium containing instructions thereon that, when executed by at least one processor, perform a method, the method comprising:
providing bidding information to a database on an information server over a data communication network by generating a data signal responsive to a user operation performed on at least one wireless communicator, wherein the user operation is indicative of the bidding information and bidding is initiated by movement of the at least one wireless communicator.

30. The non-transitory computer-readable medium product of claim 29, wherein the non-transitory computer-readable medium comprises at least one of: (i) a ROM, (ii) an EPROM, (iii) a hard disk, (iv) a non-volatile memory, (v) a memory card, and (vi) a flash memory.
